(19) United States
(12) Patent Application Publication
(10) Pub. No.: US 2026/0222678 A1
(43) Pub. Date: Jul. 30, 2026

(54) PRESET-BASED AUTOMATED IMAGE CAPTURE SYSTEM

(71) Applicant: Merrick Anthony Mosst, Taguig (PH)

(72) Inventor: Merrick Anthony Mosst, Taguig (PH)

(21) Appl. No.: 18/727,652

(22) PCT Filed: Dec. 27, 2022
(86) PCT No.: PCT/PH2022/050027

§ 371 Date: Jul. 9, 2024

(30) Foreign Application Priority Data
Jan. 12, 2022 (PH) 12022050015

(51) Int. Cl. H04N 23/60; G03B 15/07; H04N 23/56; H04N 23/611; H04N 23/62; H04N 23/63; H04N 23/69; H04N 23/695; H04N 23/72; H04N 23/74

(52) U.S. Cl. CPC H04N 23/64; H04N 23/56; H04N 23/611; H04N 23/62; H04N 23/632; H04N 23/635; H04N 23/69; H04N 23/695; H04N 23/72; H04N 23/74; G03B 15/07

(57) ABSTRACT

An automated system for capturing photos/videos and integrated methods thereof. The system makes use of lighting elements, a camera, and a simple user interface with selectable preset images. To frame the composition, the camera position is automatically adjusted according to the selected preset image and the live camera feed. The lighting arrangement as well as other system elements may be configured to maximize the compositional variety in a minimal footprint, while providing consistent results across a range of subject heights.

### CROSS REFERENCE TO RELATED APPLICATIONS

This application is a national stage 35 USC 371 entry of PCT International Application No. PCT/PH2022/050027 filed on Dec. 27, 2022, which claims priority to Philippines Patent Application No. 1/2022/050015 filed on Jan. 12, 2022. These prior applications are hereby incorporated by reference in their entireties.

### TECHNICAL FIELD OF INVENTION

This invention relates to photographic systems, and more particularly, to an automated system and methods for obtaining high quality photos and videos.

### BACKGROUND OF THE INVENTION

Professional photo/video studios are widely used around the world. The high level of quality and compositional variety available at such studios is sought by a wide range of clients in many industries, from international marketing agencies producing video advertisements to freelance professionals looking for headshots.

The demand for professional quality photos and videos has only increased in the internet age. Practically any individual (or any size business) with an internet connection can now engage in online social media or networking platforms, sharing photos/videos representing their personal or professional lives, and can even earn income from photo/video-based content through online monetization platforms.

However, while the bulk of online media is produced and uploaded by the general public, professional studios remain out of reach for a majority of this market. Professional studio productions require skilled professionals (and assistants), high-end studio equipment, a large footprint (i.e. working area), and continual reconfiguration and are therefore costly in terms of time and budget. Any lower cost option, such as hiring an amateur photographer with a home studio, will often be a compromise in terms of quality and/or variety, and will still require time for studio setup and reconfiguration. Another low-cost option might be smartphone cameras and applications which, although continually improving in capability, cannot provide the level of quality and variety from professional studios.

In recent years, studio systems have been proposed in the prior art which integrate lighting and computer control, allowing some amount of automated reconfiguration and thereby streamlining the production process and reducing costs. However, due to traditional design thinking and constraints, they generally require a large footprint and/or a complex user interface and are therefore unsuitable for general public use.

For example, the patent US 20110317057A1 proposes an automated light repositioning system which allows recallable light patterns via presets. It is designed to be a general-purpose system, and as is commonly done in traditional studios, the lighting and cameras are placed at far distances from the subject, resulting in a large footprint (relative to the subject dimensions). If the footprint were reduced, various problems would arise due to the closely spaced studio arrangement-problems related to camera distance (camera must be placed in front of the front light assembly), vertical framing (different height subjects will appear at different vertical positions in captured images), illumination angles (different height subjects will be illuminated differently), and other factors. The system is therefore not suitable for smaller footprint arrangements and is limited to relatively high budget customers.

Another example would be professional automated studio systems designed for e-commerce applications. These typically provide an arrangement of lights whose positions and orientations are fixed (or mostly fixed) along with a backdrop system and camera system which is manually (or semi-automatically) adjustable. As these systems are optimized for e-commerce applications and require various manual adjustments, they are likewise unsuitable for use by the general public. They typically require a complex user interface (to be controlled by a trained operator) as well as a large footprint. If the footprint is reduced, various problems would arise, related to vertical framing (different height subjects will appear at different vertical positions in captured images), illumination angles (different height subjects will be illuminated differently), and other factors.

A related example—but not designed for professional quality results—would be advanced photo vending machines. Although these systems are designed with a small footprint and an easy-to-use interface, even the most advanced systems are generally optimized for a singular compositional style and are limited to casual entertainment, not professional purposes.

Accordingly, new innovations are needed for an automated studio system suitable for general public use, one which is efficiently sized and easy to use while providing professional studio quality and compositional variety. Such a system would clearly have broad appeal and applications across many industries.

### SUMMARY OF THE INVENTION

An object of the present invention is to provide a space-efficient automated studio system design that overcomes the problems of existing system designs when minimizing the footprint, as described above.

Another object of the present invention is to provide higher levels of quality and variety than allowed by existing system designs, which are limited in terms of lighting and background patterns and are unable to provide professionally edited images automatically.

Yet another object of the present invention is to provide users with intuitive tools for pose guidance as well as creative adjustment which are lacking in existing systems.

These, as well as still further features, objects and benefits of the invention are obtained by a novel preset-based automated image capture system.

In a first aspect of the invention, there is provided a preset-based automated image capture system in operative association with a computer system, said computer system is configured to: display a plurality of preset images on the display device, receive a signal indicating a preset image selection via the input device, determine a first reference point based on the selected preset image, retrieve at least one frame from the image sensor based on a predetermined evaluation frequency, evaluate a second reference point on the retrieved frame; and actuate the mounting device to perform the at least one framing movement to align the second with the first reference point.

In a second aspect of the invention, the system further comprises a plurality of lighting elements surrounding a photographic zone, at least one backdrop mounted to a motorized roller, an image capture device comprising said image sensor, a software graphical user interface presented on at least one display, elements and processes by which the elevation angles of the lighting elements may be automatically adjusted, and elements and processes by which the compositional styles may be automatically adjusted upon selecting a preset in said software graphical user interface.

In a third aspect of the invention, the system further comprises a pan and tilt control for the image capture device, image processing algorithms in the software application, intuitive tools for creative adjustment, and software graphical user interface elements for pose guidance.

In a fourth aspect of the invention, there is provided a computer-implemented method for framing adjustment of an image capture system, and a non-transitory computer-readable medium for performing the method thereof, the method comprising the steps of: displaying a plurality of preset images on a display device, receiving a signal indicating a preset image selection via an input device, determining a first reference point on the selected preset image, retrieving at least one frame from an image sensor based on a predetermined evaluation frequency, evaluating a second reference point on the retrieved frame; and actuating an image sensor mounting device to align the second reference point with the first reference point.

In a fifth aspect of the invention, there is a plurality of preset-based automated image capture systems utilizing a central computer system or server for retrieving a plurality of computer-readable instructions corresponding to each of the plurality of systems.

The disclosed system may be configured by the system designer in many possible formats according to the intended use and expected dimensions of subjects, whether persons, products or other living beings or inanimate objects. As such, the invention is beneficial for a wide variety of applications including photo kiosk machines, e-commerce oriented systems, and any application that may benefit from professional images to be captured quickly and efficiently with a minimum of space and user training required.

These as well as still further features, objects and benefits of the invention will now be presented in the following detailed description and the accompanying drawings.

### BRIEF DESCRIPTION OF THE DRAWINGS

FIG. 1 is an illustration of an exemplary image capture system according to the invention as viewed from an isometric perspective.

FIG. 2 is a right-side view of the system shown in FIG. 1.

FIG. 3 is a rear view of the system shown in FIG. 1.

FIG. 4 is a reference three-dimensional coordinate system used to define light source angles.

FIG. 5 is an illustration of an exemplary rear-pointed lighting element configuration.

FIG. 6 shows lighting patterns upon a mannequin head when activating individual lighting elements in a real prototype of the embodiment shown in FIG. 1.

FIG. 7 shows lighting patterns upon a mannequin head when activating combinations of lighting elements in a real prototype of the embodiment shown in FIG. 1.

FIG. 8 shows background patterns when selecting different backdrops in a real prototype of the embodiment shown in FIG. 1.

FIG. 9 is a block diagram of an automated vertical framing method in accordance with a preferred embodiment of the invention.

FIG. 10 shows example representations of a preset image and a live feed from an image capture device to illustrate the process in FIG. 9.

FIG. 11 is a block diagram of system operation for a new user session in accordance with a preferred embodiment of the invention.

### DETAILED DESCRIPTION

The invention disclosed herein describes a preset-based image capture system which is efficiently sized and easy to use while providing professional studio quality and compositional variety. The innovative elements of the invention overcome many of the challenges related to a closely spaced studio arrangement and go beyond the limits of previous systems in terms of lighting and background patterns, professionally edited looks, intuitive controls for creative adjustment, and pose guidance.

The invention is beneficial to any application where professional studio photos and/or videos should be captured quickly and efficiently with a minimum of space and user training required. For example, coin-operated photo vending machines may be built according to the invention to make professional studio photography accessible to the general public at an affordable price. As another example, e-commerce oriented systems may be built according to the invention to rapidly shoot professional photos and videos of products in a small space. Amateur and professional photographers (as well as studio businesses and their clients) may also benefit from the time and space efficiencies in terms of equipment setup and reconfiguration as well as from various other features and automations as disclosed herein.

To clarify regarding terminology used throughout the specification and the appended claims, it will be understood that the term “composition” refers to the complete arrangement of a subject (or subjects) upon a background in a captured image—the term therefore encompasses lighting patterns, background scenery, posing of subject(s), perspective, framing, and all such characteristics and their aesthetic relationships in a captured image. The term “background” refers to the portion of the scenery being captured which is behind the subject (if a subject is present), whereas the term “backdrop” refers to a physical material which may be placed behind the subject to adjust the background in captured images. The term “user” refers to the person (or multiple persons or other intelligent entity) controlling the system interface, whereas the term “subject” refers to the person or other living being or inanimate object (or plurality thereof) whose image is being captured. Throughout the specification and appended claims, the user is often assumed to be the subject, but this may not always be the case as can be inferred by the context. It will further be understood that the term “images” refers to both photos (single images) and videos (multiple images in sequence), unless indicated otherwise by context. The term “system,” unless otherwise specified (e.g. as a computer system) refers to the entire automated image capture system.

In a preferred embodiment, the system comprises an outer structure that defines the outer physical dimensions of the system. The outer structure may be constructed by various means and materials. For example, the outer structure may be comprised of walls which are comprised of a rigid material such as wood, metal, or plastic, and braced or glued together. In another example, the outer structure may be comprised of a skeletal frame comprised of interconnecting wood, metal, or plastic beams which may be covered in a removable sheet comprised of a flexible or foldable material such as woven fabric. With an appropriate selection of lightweight materials and interconnecting components, the outer structure may be designed to be easily disassembled and reassembled for portability. Wheels may also be added to the bottom of the structure to add mobility. If the system is placed near surfaces (e.g. walls in a larger room), the nearby surfaces themselves may be substituted as the outer structure, in full or in part. The outer structure, in full or in part, may serve the secondary purpose of mounting system components. Alternatively or additionally, a separate inner structure (or multiple separate inner structures or any other suitable structural variation) may be used for the said mounting. It will be understood that an outer structure is not necessarily essential to the invention and may therefore be omitted (in full or in part) at the discretion of the system designer, provided other structures are available to accommodate the system components as described herein.

Although the illustrated embodiment shows a fully enclosed space allowing a private session for the user, the system may be constructed in a partially or fully open manner for purposes where privacy is not a concern. For an enclosed space, the inner surface of the enclosure is preferably an achromatic color such as white, gray, or black. The shade of color may be selected by the system designer according to the intended aesthetics: darker inner surfaces will result in reduced internal light reflections and potentially darker shadows (and higher contrast), whereas lighter inner surfaces will result in more internal light reflections and potentially lighter shadows (and lower contrast).

Whereas the embodiment is illustrated in a fixed system size as defined by the outer structure, a variable size (or modular) system may be constructed to make advantageous use of the present invention. A variable size system may be constructed in various ways, such as incorporating telescoping components (to extend the length, width, or height of the system) into an outer skeletal frame. A variable size (or modular) system may be preferred for applications where the subjects may vary significantly in size (e.g. groups of persons versus a small animal), or where extra standing or sitting space may be needed inside or outside the photographic zone, or for various other reasons.

Whereas the illustrated embodiment shows an entrance on the left side of the system, an entrance may be provided on the right side and/or on any side (or any position) as allowed by a particular system configuration. A system might accommodate a rear entrance, for example, if obstructive elements at the rear are omitted or designed to be moved out of the way (e.g. rolled up like a curtain or built into a rear assembly that may open and shut like a hinged door).

Whereas the illustrated embodiment is of a rectangular shape, the system may be designed to take any suitable shape, whether cylindrical, semi-spherical or other three-dimensional shape, as may be suitable for the expected (total) dimensions of the subject(s), for the intended outer appearance or for any other technical or design criteria.

Whereas the illustrated embodiment is characterized by a height greater than width (i.e. left to right side), the system may be designed in any proportion for the purpose of the system, considering the expected (total) dimensions of the subject(s). It will be understood that a system proportion whose height is greater than width may be more optimal for capturing images in portrait orientation (i.e. image height dimension is greater than width), whereas a system proportion whose width is greater than height may be more optimal for capturing images in landscape orientation (i.e. image width dimension is greater than height).

For reference, the illustrated embodiment requires a floor area of approximately 1.5 meters (width) by 2.5 meters (length), allowing a maximum of around two persons standing side-by-side to be captured in full width when standing towards the rear of the system, with a maximum of about three-quarter length framing (from subjects' top of head down to the thighs), under assumptions regarding image aspect ratio, subject dimensions, lens specification and setting, and margin above the head of the subject(s)s in captured images, among other factors.

Whereas the illustrated embodiment is tailored to a small number of persons and therefore within the typical size range of photobooth systems designed for the general public, the system may be designed to accommodate any number of persons (or subjects of any kind) while still being within the scope of the invention. It will be appreciated that a system designed to accommodate many persons may not have a “small” footprint in the absolute sense, but its footprint will still be small in relative terms—i.e. relative to the subject dimensions—considering the area required to achieve the degree of compositional variety and light pattern consistency as allowed by the present invention.

In a preferred embodiment, a plurality of individually addressable lighting elements surrounds a photographic zone so as to produce aesthetically relevant lighting patterns upon a subject from a plurality of angles. To this end, portrait lighting patterns are chosen as a guide since their aesthetic value has been proven in traditional photography (at least for human subjects). The target portrait lighting patterns as used in a preferred embodiment are as follows: Paramount/Butterfly, Rembrandt, Split, Kicker/Rim, Vertical Clamshell, and Horizontal Clamshell. Therefore, the system preferably provides an arrangement of lighting elements such that the said target portrait lighting patterns may be achieved, with respect to a reference subject head position within the photographic zone and facing the front of the system. It will be appreciated by those trained in photography that the Vertical Clamshell pattern may be achieved by combining a light in Paramount/Butterfly position with a lower lighting element to fill in shadows, which will be referred to herein as a Vertical Clamshell Fill light.

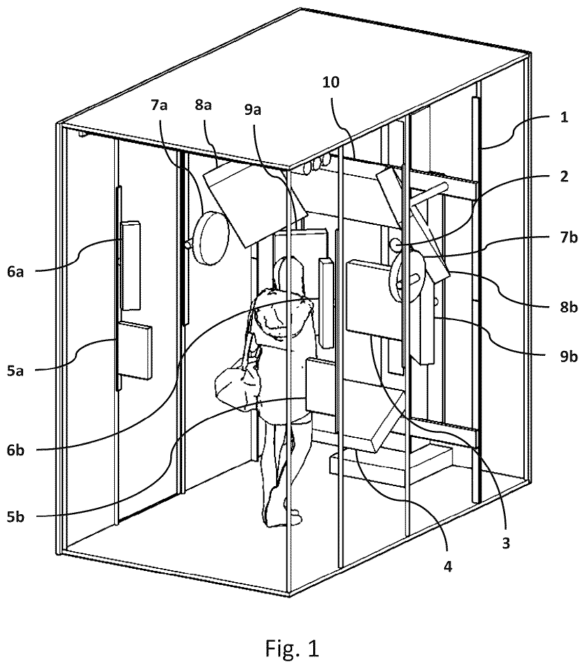

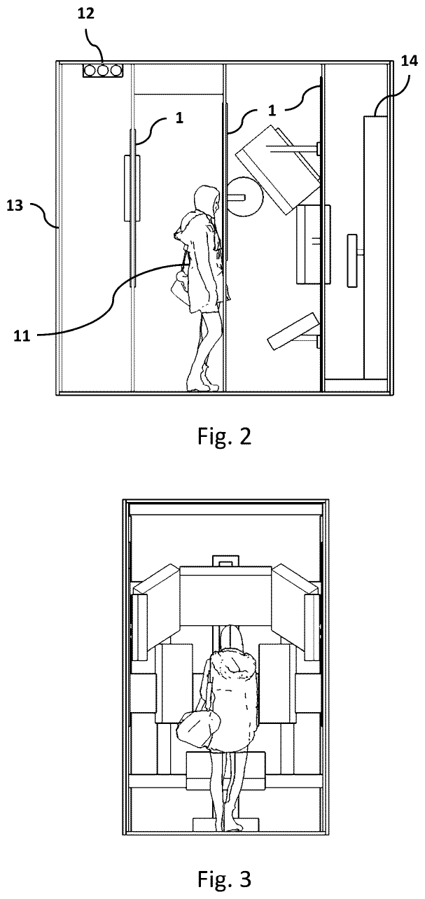

FIGS. 1-3 illustrate a preferred embodiment of the invention, showing a plurality of lighting elements surrounding a photographic zone in a room-like environment. A human subject 11 is shown standing in the photographic zone (not exactly in the reference subject head position) for illustration purposes. The photographic zone may comprise a front section and a rear section, in which the lighting elements may be disposed. The front section is the side of the photographic zone comprising the image capture device 2 while the rear section is the side comprising the backlit panel 13. For illustration purposes, the rear and right-side walls are removed in FIG. 1, the right-side wall removed in FIG. 2, and the rear wall removed in FIG. 3. The lighting elements in the embodiment in FIG. 1 are positioned as follows: a lighting element 10 in Paramount/Butterfly position, two lighting elements 8a & 8b in Rembrandt position, two lighting elements 7a & 7b in Split position, two lighting elements 6a & 6b in Kicker/Rim position, a lighting element 4 in Vertical Clamshell Fill position, and two lighting elements 9a & 9b in a Horizontal Clamshell position. The aforementioned lighting elements will herein be referred to as subject-illuminating lighting elements. The above lighting arrangement was designed to produce all the target portrait lighting patterns with the fewest components, thereby maximizing the number of useful lighting patterns in a minimal footprint. It will be understood that some ambiguity is inherent in the portrait lighting pattern terminology, not only due to photographers' artistic opinions but also due to the variations in structure of every human face. This ambiguity has been taken into account when specifying the lighting element angles, as described later.

It will be understood that the portrait lighting terminology is used herein as a design principle for arranging the lighting (around a reference subject head position) as well as a matter of convenience when labeling the lighting element positions. Since subjects may position themselves in various positions in the photographic zone during the operation of the system, as will be described later, the resultant lighting patterns upon the subjects may differ from the lighting pattern terminology used for labeling the lighting element positions—for example, the Paramount/Butterfly lighting element 11 may not actually produce an exact Paramount/Butterfly lighting pattern on a subject's head if the subject were to move away from the reference subject head position. Therefore, the lighting pattern terminology is not intended to describe the character of light across all possible subject positions and all types of faces. It will be further understood that the system may be used to capture images of any type of subject(s), whether persons or products or other living beings or inanimate objects, and that the terminology is not intended to limit the system use cases to human subjects only.

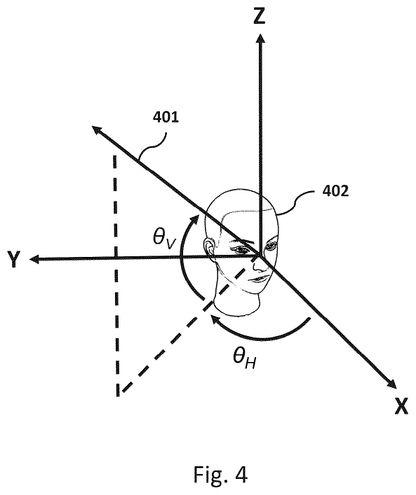

For further guidance regarding lighting element angles, the recommended central angles for the subject-illuminating lighting elements are described in Table 1 below. The recommended central angles are relative to a reference subject head position in the three-dimensional coordinate system shown in FIG. 4. Three orthogonal axes X, Y, and Z define the three-dimensional space, wherein the direction of a lighting element's central position 401 may be described by a pair of angles: the central azimuth angle ϑ_{A} and the central elevation angle ϑ_{E}. The direction which is ‘directly forward’ with respect to the reference human head 402 is the X axis, which corresponds to an angle of ϑ_{A}=0° and ϑ_{E}=0°. A recommended angular range (minimum to maximum) for each lighting element is provided in Table 1. For example, a Paramount/Butterfly lighting element is preferably placed such that its central point of radiation is located in the range −15° to +15° azimuth, +15° to +65° elevation with respect to the reference subject head position. It will be understood that the recommended range of angles in Table 1 may be larger than might be traditionally associated with the lighting pattern terminology (e.g. “Paramount”), which is due to the fact that the subject(s) has freedom to move around in the photographic zone, thereby broadening the range of lighting angles that may produce the target portrait lighting patterns upon the subject(s).

TABLE 1
Recommended range of central angles for lighting elements

| Lighting Element | Central Azimuth | Central Elevation |
|---|---|---|
| (Reference Term) | Angle ϑ_{A} | Angle ϑ_{E} |
| Paramount/Butterfly | −15° to +15° | +15° to +65° |
| Rembrandt (Left) | −15° to −75° | +15° to +65° |
| Rembrandt (Right) | +15° to +75° | +15° to +65° |
| Split (Left) | −75° to −115° | −15° to +25° |
| Split (Right) | +75° to +115° | −15° to +25° |
| Horizontal Clamshell (Left) | −25° to −75° | −15° to +25° |
| Horizontal Clamshell (Right) | −25° to −75° | −15° to +25° |
| Vertical Clamshell Fill | −15° to +15° | −80° to −20° |
| Kicker/Rim (Left) | −120° to −170° | −30° to +30° |
| Kicker/Rim (Right) | +120° to +170° | −30° to +30° |

Whereas a preferred embodiment comprises a plurality of lighting elements, it will be understood that only a subset of lighting elements need be present to achieve an object of the invention. Considering the inclusion of other system elements which will be described later, a wide variety of compositions may be captured even if a single subject-illuminating lighting element is present.

It will be understood that many variations on the lighting element configuration may be possible while still being within the scope of the invention. For example, any lighting element may be comprised of a plurality of adjacent lighting elements (e.g. an array of LEDs), which may be addressable as a single unit or individually. In another example, a plurality of additional lighting elements is added to expand the range of available light patterns, the said elements including hair lights, top/overhead lights, direct frontal lights (close to the location of image capture), ambient lights (e.g. light arrays covering large inner surfaces), and others. In another example, some lighting elements may be arranged asymmetrically (with respect to the lengthwise central axis or other perspective of the system) as a means of reducing the system size and/or providing additional lighting patterns or variations of lighting patterns.

As will be appreciated by those familiar in the art of photography, although some lighting element positions are typically used as primary light sources (a.k.a. “key” lights)—i.e. configured to produce the dominant lighting pattern on the subject—any lighting element or combination thereof may be used as a primary light source to achieve an aesthetic effect. For example, Kicker/Rim lights are not typically used as primary light sources since they only illuminate the edges of a subject, but they may actually be used alone as primary light sources to achieve a high contrast “edge lighting” effect.

In a preferred embodiment, additional individually addressable lighting elements are provided for background illumination. The target background lighting patterns (whose aesthetic value has likewise been proven by traditional photography) used in a preferred embodiment are the Vignette/Spotlight and the Uniform Backlight. Accordingly, two rear-pointed lighting elements 5a & 5b are provided for the Vignette/Spotlight pattern, and a backlit panel 13 is provided for the Uniform Backlight pattern. The above lighting elements are herein referred to as the background-illuminating lighting elements and are discussed in detail later.

Both the subject-illuminating lighting elements and background-illuminating lighting elements are preferably configured such that, when activated, the lighting will emanate continuously. This may be achieved by the use of continuous-type lighting elements and/or the use of so-called “modeling lights,” which are continuous-type lighting elements that accompany separate flash-type (i.e. stroboscopic) lighting elements. If any flash-type lighting elements are included, they would preferably be accompanied by modeling lights. One benefit of continuous-type lighting is that it enables a subject to preview himself/herself in photographic lighting before a photo is captured (assuming the subject is provided a mirror or preview display). It will be appreciated that the operation of a continuous-type lighting element may be adjusted to mimic the operation of a flash-type lighting element with a modeling light, simply by emitting a high-intensity and short-duration flash of light at the moment an image is captured, while emitting a lower-intensity light otherwise—this may help save on power consumption and may also help subjects avoid eye fatigue from continuous bright light.

The lighting elements may be comprised of any intensity-adjustable element such as LED, fluorescent, incandescent, and halogen. The type of lighting elements may be mixed and matched at the discretion of the system designer—for example, LED lighting elements may be used in one position in the system while incandescent elements are used in another position, whether directly adjacent or not. It will be understood that the use of energy efficient lighting elements such as LEDs may significantly improve the operational cost and cooling requirements of the system. It will be further understood that lighting elements designed for photographic/videographic purposes may produce better aesthetic results than those designed for other applications.

Any or all of the lighting elements may be color changeable, to allow the subject to be illuminated with colorful patterns. As will be appreciated by those trained in the art, color changeability may be achieved by varying the intensities of multi-colored light-emitting diodes such as RGB LEDs, or by varying the intensity of a plurality of white lighting elements modified with color gel films, or by various other means.

The subject-illuminating lighting elements may be modified in such a way as to allow pleasantly soft light with a wide radiation angle. Soft light with a wide radiation angle may be achieved by way of traditional photographic lighting modifiers such as soft boxes, umbrellas, and beauty dishes, possibly in combination with one or more layers of light-diffusing material. Any shape of modifier may be suitable, whether rectangular, square, or other shape. Soft light with a wide radiation angle may alternatively or additionally be achieved using a plurality of smaller soft lighting elements adjacent one another, each with a wide radiation angle. However, it will be understood that using hard lighting elements—e.g. a bare bulb—and/or modifiers for narrower radiation angles such as directional grids, barn doors, or snoots—may produce aesthetically relevant light patterns as well. One of the advantages of the illustrated embodiment is that lighting elements of any particular aesthetic qualities may be incorporated at any particular mounting position to achieve target aesthetics, at the discretion of the system designer. For example, a beauty dish modifier may be used in Paramount position whereas soft boxes may be used in Rembrandt position. In another example, Kicker/Rim lighting elements may be modified with grids to prevent spillage onto the background as well as lens flare.

The rear-pointed lighting elements 5a & 5b are preferably positioned and modified in such a way as to produce a vignette (a.k.a. spotlight) effect in the background scenery of captured images. As will be appreciated by those trained in the art, a vignette effect may be described by a central area of illumination whose brightness is gradually reduced towards the edges. Such an effect may add depth and interest to images and may be achieved using rear-pointed lighting elements equipped with modifiers (such as reflectors or barn doors or directional grids) and directed towards the center of the backdrop. Additional rear-pointed lighting elements may be advantageously employed at other locations in the system such as above/below 5a and 5b or above/below the backdrop or other location outside the view of the image capture device 2, allowing potentially greater control over the background lighting pattern(s) and/or higher intensity output.

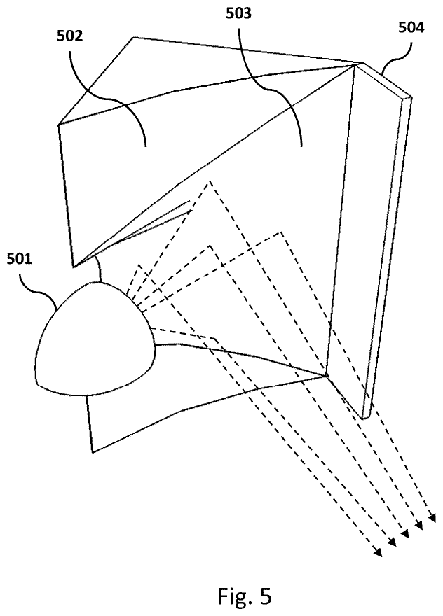

When rear-pointed lighting elements are placed at a shorter distance to backdrop surfaces, however, it becomes more challenging to maintain a central area of illumination upon the backdrop. One solution to this problem is the rear-pointed lighting element configuration in FIG. 5, wherein a lighting element 501 is directed towards a concave reflective surface 503 designed to reflect the light radiation (indicated by the dotted lines) towards a central area of the backdrop. The concave reflective surface 503 is preferably constructed of a specular reflective material with a neutral spectral reflectance (i.e. no significant colorization) such as silver, tin, nickel, chromium, aluminum, mylar, or reflective paints, films or any such materials with specular reflective properties. The particular dimensions and curvature/shape of the concave reflective surface 503 as well as the position/orientation of the lighting element 501 may be specified by the system designer according to the desired background lighting pattern, whether a strong vignette with a small central hotspot (symmetrical or asymmetrical in shape) or more evenly distributed background lighting. It will be understood that the dotted lines are shown for illustrative purposes and do not represent the entirety of the light (in terms of direction and intensity) radiating from lighting element 501 and reflected from the concave reflective surface 503. A barrier/flap piece 504 made of a non-transmissive and non-reflective material is preferably included to prevent the lighting element 501 and reflections thereof from illuminating a subject in the photographic zone. Other surfaces in this configuration, such as a surface 502 structurally supporting the concave reflective surface 503, are preferably non-reflective to prevent unintended illumination. The configuration in FIG. 5 corresponds to the left-side rear-pointed lighting element 5a in FIG. 1, so another such element may be used in a symmetrical configuration for the right-side position 5b, enabling at least a horizontally symmetrical background illumination pattern in captured images (when both lighting elements 5a and 5b are configured with horizontally symmetrical radiation patterns). Many variations on the said configuration may be employed, such as using multiple lighting elements in place of lighting element 501 directed towards the concave reflective surface 503, or modifying the radiation pattern of the lighting element 501 with grids, diffusers and/or other lighting modifiers to further shape the background lighting pattern. One addition or alternative to the said configuration may be a lighting element directed towards the backdrop and modified with a light-transmissive material having an asymmetric transmission pattern (to achieve a vignette or other background lighting pattern).

The above lighting arrangement, in combination with the ability of each lighting element to be individually addressable by the system, represents one aspect of the invention. The lighting system (including subject-illuminating and background-illuminating components) provides the unique benefit of a plurality of switchable lighting patterns, each of whose aesthetic value has already been proven by traditional photography. The benefit is further augmented by allowing adjustable framing of the scene (as described later) such that the user may position himself/herself in different locations in the photographic zone, thereby greatly expanding the range of lighting patterns available. Although the portrait lighting patterns upon which the system is based are limited in number, a surprising result found by experimentation is that when used in combinations of intensities and allowing for framing adjustment, the majority of studio lighting aesthetics produced by professionals (as may be found in various media and publications) may be closely simulated, if not fully achieved.

Moreover, as will be described in more detail later, the subjects may generally reposition themselves (or may be repositioned by others) as they wish, allowing substantial freedom of expression. Whereas professional photographers might raise concerns about allowing a subject the freedom to move around within a closely spaced lighting arrangement, it is the inventor's finding that if the lighting arrangement (and system) is provided as described, subjects are very well capable of positioning themselves to produce professional quality results in various positions. Additionally, the subject(s) may feel an even greater sense of freedom if the system is designed to be fully enclosed for private sessions, which might be especially appealing to those who are uncomfortable posing in front of a photographer (or others). Other aspects of the invention further enable subjects to produce professional quality compositions, by themselves, automatically, as will be described in due course.

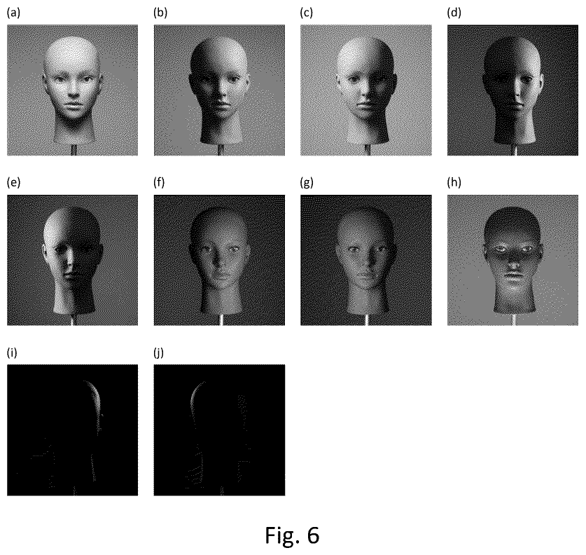

FIGS. 6-8 show lighting and background pattern examples captured with a real prototype of the illustrated embodiment in FIG. 1. For all captured photos, a mannequin head was placed in a fixed reference position around which the lighting elements were arranged according to the invention. While capturing photos, the camera was kept in a fixed position. After all photos were captured, the photos were manually cropped to the same square ratio in a photo editing application.

FIG. 6 shows lighting patterns resulting from each of the subject—illuminating lighting elements turned on individually—Paramount/Butterfly (a), Rembrandt Left (b), Rembrandt Right (c), Split Left (d), Split Right (e), Horizontal Clamshell Left (f), Horizontal Clamshell Right (g), Vertical Clamshell Fill (h), Kicker/Rim Left (i), and Kicker/Rim Right (j). A white backdrop was present when capturing these images.

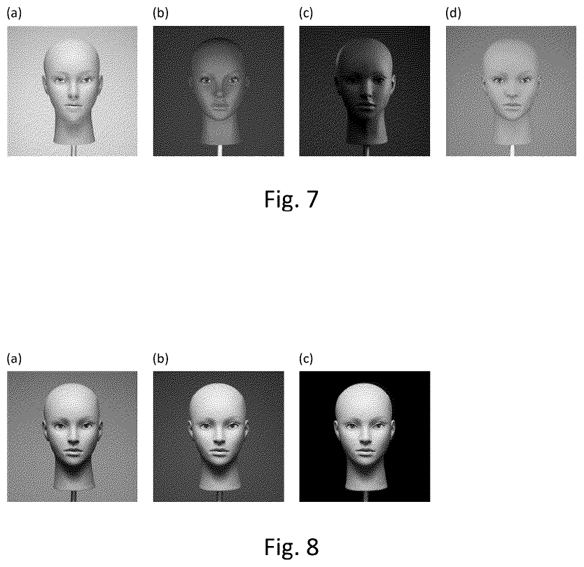

FIG. 7 shows example lighting patterns produced when activating subject-illuminating lighting elements in combinations of intensities. These particular combinations might be described with the following photographic terminology: Vertical Clamshell (a), Horizontal Clamshell (b), Two Point Lighting (Key+Rim) (c), and Flat (d). This set of photos demonstrates how various aesthetic effects may be achieved by the proposed lighting arrangement, even with a single subject position. It will be understood that many additional light patterns may be produced by adjusting the intensities and/or colors of all lighting elements as well as by repositioning the subject within the photographic zone.

FIG. 8 shows background patterns produced when different backdrops are selected. When capturing these photos, only the light 11 in Paramount position was turned on. Each photo corresponds to a different backdrop selected in the prototype—white (a), gray (b), or black (c).

Given a fixed lighting arrangement as described above, the system designer may formulate a plurality of unique lighting patterns by orienting a reference human subject (of the same height as the reference subject head position used for arranging the lighting elements) in various positions and poses—e.g. standing in the center of the photographic zone or sitting on a stool towards the left side of the photographic zone—and adjusting the light element intensities until the desired aesthetics are achieved. As will be described later, such a plurality of unique lighting patterns may be stored as presets and recallable via system software. This preset-based system with a fixed lighting arrangement will produce consistent results only for subjects of the same height as the reference human subject, whereas taller and shorter subjects will not experience the same lighting patterns. If a taller or shorter subject were to select a preset and position himself/herself in the same way as the reference human subject for which the selected preset was designed, the relative elevation angles of the lighting elements will be different and therefore result in different lighting patterns than intended by the system designer.

It will be understood that other automated image capture systems avoid this problem of light pattern consistency to some extent by using the traditional approach of increasing the distance between the subject and the lighting elements. At far enough distances, the elevation angles of the lighting elements will not vary significantly relative to different height subjects, allowing for somewhat consistent light patterns across a range of subject heights. However, this approach has the undesirable consequence of a large footprint both in the absolute sense and also relative to the number of users the system may accommodate. Likewise, a simple reduction in size of such systems would result in a small footprint but with inconsistent light patterns, among other potential issues which the present invention resolves.

To allow for consistent light patterns across a range of subject heights, a preferred embodiment provides an adjustable mounting mechanism for the lighting elements. This is accomplished in the illustrated embodiment in FIG. 1 by way of vertical guide rails 1 along with an electric hoist system (not shown). When the hoist system is activated to move the lights upwards, for example, this effectively shifts the reference subject head position higher such that the intended elevation angles of the lighting elements will be preserved for a correspondingly taller subject. Many various alternatives may be implemented to allow elevation adjustment of the lighting elements, including non-motorized mechanisms (e.g. sliding rails with a pulley and winch system, sliding shaft mounts with pulleys and counterweights, ceiling-mounted pantographs, or traditional studio light stands) or motorized mechanisms (e.g. motorized pantographs, belt-driven mechanisms, or linear actuators) or a combination of motorized and non-motorized mechanisms. Any adjustable mounting mechanism may be used for any particular lighting element. The elevation adjustment trajectory may be linear and/or may have a curved characteristic which may be beneficial, for example, in a system whose outer structure is designed with a curved shape.

A formula that may be used for setting the elevation of the lighting elements for any particular subject is as follows: the elevation of the lighting elements may be set to the “original” reference elevation (based on the reference subject head height around which the lighting elements were arranged) plus the subject height minus the reference subject head height. According to this formula, taller subjects would require higher elevations of the lighting elements as compared to the original reference elevation, and vice versa for shorter subjects. It is possible that no change in elevation of the lighting elements is needed if the said elevation has already been set for a subject of approximately the same height. When multiple subjects are present, the “subject height” in the above formula may be set to the average or maximum height of the subjects, or other numerical approach. It is left to the system designer to determine the most appropriate formula and operation for setting the elevation of the lighting elements, whether a single subject or multiple subjects are present. It will be understood that if multiple subjects are present in the photographic zone, each subject will experience different light patterns and exposures. However, this is generally not a concern because the height difference between companions is generally not large relative to their distances to the lighting elements, and any differences in lighting patterns and exposures may be used to good aesthetic effect anyway.

In the operation of the system, the height of the subject(s) may be accounted for in various ways, using motorized and/or non-motorized means. For example, if a system operator is present and a single user intends to use the system, the user may simply tell the operator their height (or the height of the intended subject), and then the operator would adjust the elevation of the lighting elements (and perhaps other system components) accordingly. In another example, the user may be prompted to enter their height at the beginning of the system operation, after which the system may automatically adjust the elevation of the lighting elements by motorized means. In another example, the system uses an automated height detection scheme (such as prompting the subject to stand in a particular pre-calibrated position and then capturing an image to estimate the subject height) at the beginning of a new session and then adjusts the lighting elements accordingly. The elevation of the lighting elements may be adjusted once at the start of the session or may be adjusted continuously throughout a session according to the height of the subjects present in the photographic zone (or other factors), which might be accomplished in an automated fashion by motorized means. It is left to the system designer to determine the most appropriate operation for setting the elevation of the lighting elements, whether adjusted at the start of the session, during the session, or at any other time or plurality of times.

One alternative to adjusting the elevation of the lighting elements is to adjust the elevation of the subject(s). A height-adjusting platform may be implemented in the floor area of the photographic zone, wherein the height of the platform may be adjusted without affecting the elevation of the lighting elements, such that subjects may be elevated to the appropriate height required to preserve the relative elevation angles of the lighting elements. Such a platform may use motorized elements (e.g. hydraulic scissor lift) or non-motorized elements (e.g. a platform whose elevation is increased by stacking together layers of materials such as wood) or a combination of motorized and non-motorized elements. The elevation adjustment of the subject(s) might be a manual process (e.g.

the user sets the elevation themselves), an automatic process (e.g. the system detects the subject height and adjusts the elevation by motorized means) or a combination of manual and automatic processes, and the adjustment may be performed by a system operator or by the subject(s) themselves.

Another alternative to adjusting the elevation of the lighting elements is to provide a plurality of individually addressable, substantially vertically stacked lighting elements for each of the intended lighting element positions, wherein the subject's height will be used as an input parameter to the system. In this case, the height range of the vertically stacked lighting elements (from the top of a stack to the bottom) will substantially determine the height range of subjects that may be accommodated (while preserving the relative elevation angles of the lighting elements). Accordingly, the subject's height, whether entered manually or determined automatically, will serve as an offset value that determines which of the lighting elements within each vertical stack should be activated in order to preserve the relative elevation angles. Lighting elements that may obstruct the operation of other components might be elevated by other means—e.g. the Paramount/Butterfly lighting element and Vertical Clamshell Fill lighting element might be mounted to the motorized stand 14 to avoid obstructing the view of the image capture device 2 if the said lighting elements were stacked.

In a preferred embodiment, multiple lighting elements 11, 8a, 8b, 4, 9a, 9b-hereinafter referred to as the “front lighting elements”—are mounted to a front crossbar assembly which is in turn mounted to the vertical guide rails 1, whereas all other subject-illuminating lighting elements as well as the rear-pointed lighting elements 5a & 5b are directly mounted to their respective vertical guide rails 1. The said front crossbar assembly couples the vertical positions of the front lighting elements 11, 8a, 8b, 4, 9a, 9b such that the said vertical positions may be adjusted simultaneously. Various alternatives to the mounting configuration are possible—for example, any combination of lighting elements could be mounted to coupling mechanisms (e.g. crossbars or walls), or each lighting element may be adjustable individually (no coupling mechanism present). It will be understood that the front crossbar assembly may be any type of structure that provides mounting locations for the front lighting elements, such as a wall mounted to the vertical guide rails 1 and comprising mounting locations for the front lighting elements.

In a preferred embodiment, a visually unobstructed path from the photographic zone through the front-positioned lighting elements is maintained such that images may be captured from a location behind the front positioned lighting elements. This provision allows images to be captured from an appropriate distance, thereby avoiding excessive perspective distortion while keeping the system footprint minimized. A related benefit is that when lighting elements are placed closer to a subject, the quality of light becomes softer (due to the relatively larger light source with respect to the subject's dimensions).

In a preferred embodiment, the mounting of all subject-illuminating lighting elements is configured in such a way as to point the said lighting elements substantially towards the reference subject head position (around which the said lighting elements are arranged). This provides the benefit of maximizing the light source size as well as the light exposure upon the reference subject head position (as well as the photographic zone in general). For example, if a particular lighting element comprises a bulb in a beauty dish, then the front of the beauty dish may be mounted in such a way as to directly face the reference subject head position. Note that the above mounting recommendation refers to the angles at which the lighting elements themselves are rotated, as opposed to the central azimuth and central elevation angles used in positioning the lighting elements around the photographic zone. It will be understood that the above mounting recommendation may be accomplished by way of adjustable mechanisms (e.g. ball head mounts) or by custom designed fixed-angle mounts or by various other means, whether mounted to a floor standing structure, to the system ceiling or other physical location. It will also be understood that the above recommendation is not critical to the performance of the system, i.e. the benefits of the invention will not be substantially reduced if not strictly followed.

In a preferred embodiment, the system provides a means of adjusting background scenery by way of backdrops and rear-mounted lighting. This is achieved in the illustrated embodiment by way of at least one backdrop mounted to motorized rollers 12 and a backlit panel 13. Although three rollers are shown in the illustrated embodiment, the number may be increased or decreased at the discretion of the system designer, with each additional backdrop potentially allowing for an additional unique background aesthetic (in terms of characteristics such as color and texture). Each backdrop may be comprised of any material that allows itself to be rolled up, such as woven cotton or polyester, perforated fabrics, canvas, vinyl, or combinations thereof. Each of the motorized rollers 12 contains a single backdrop material which, when fully extended in ‘down’ position, will change the backdrop scenery in captured images. Various mechanisms may be included to help control the backdrop roller positions, such as rotary encoders for each of the motors or proximity sensors to detect backdrop material locations. Counterweights may be attached to the bottom of any of the backdrops in order to keep them taut.

An additional backdrop may be mounted in a substantially fixed position behind the motorized rollers 12, such that when all of the plurality of backdrops mounted to motorized rollers 12 are in ‘up’ position, only the fixed-position backdrop will appear in the background scenery in captured images. It will be appreciated that a white translucent material may be most appropriate, so as not to substantially diminish or alter the light output of the backlit panel 13 (discussed further below).

An alternative backdrop roller configuration might be a paired two-roller configuration—e.g. upper and lower horizontal roller pair, or left and right side vertical roller pair—in which a single long material is comprised of multiple backdrop materials that are stitched together and mounted to the motorized rollers in some fashion, e.g. as an endless material on a conveyer belt or wound to the rollers like an industrial/theatrical roller assembly. In this configuration, the selection of a backdrop material (and its characteristic color and texture) requires rotating the rollers together in the required direction to reach the appropriate position. In the said paired two-roller configuration with an upper and lower horizontal roller, the lower roller may be positioned underneath a raised transparent platform such that the backdrop may appear to extend below the subject(s) and continue out to the front of the photographic zone in captured images. An “infinity curve” effect, which is commonly sought in studio photography, may be achieved by allowing the said backdrop material to curve around the floor-wall corner such that the corner is obscured, in which case a backdrop of a uniform aesthetic characteristic (e.g. solid white throughout) will cover the entire background in captured images.

In a preferred embodiment, the backlit panel 13 comprises a color-changeable and intensity-adjustable light array positioned behind a light-diffusive material, such as diffuser-white acrylic panels or opal diffuser sheets. The light array may be forward firing (i.e. radiation maxima pointed towards the front of the system) to maximize the light emanating into the photographic zone. The distribution of elements of the light array may be configured to be uniform and cover the entire backdrop area such that, when placed behind a light-diffusive material and the light array emitting a single-color light, the background scenery would appear as a substantially uniform color in a captured image. If a fixed-position backdrop is included as mentioned earlier, the fixed-position backdrop may itself be utilized as a light-diffusive material for the light array if it is sufficiently effective at diffusing the light.

Other backlit lighting configurations are possible, such as rim-mounted lighting elements in combination with a light guide plate, or a rear-firing light array in combination with a reflective rear surface (towards which the rear-firing light array is pointed), or a plurality of light panels, each with its own lighting configuration. Whereas the light array may be configured such that it is addressable by the system as a single lighting element, an array comprising individually addressable lighting elements may be used for greater versatility in controlling the background scenery.

In a preferred embodiment, the backdrop materials mounted to motorized rollers 12 are not perfectly light-blocking (i.e. may transmit some light), thereby allowing the lighting from the backlit panel 13 to modify the background scenery while a backdrop is in the ‘down’ position. For example, if a light-transmissive gray backdrop is in the ‘down’ position while red lighting elements are turned on in the backlit panel 13, the resulting background may appear as a reddish-gray color in captured images. It will be understood that light-transmissive materials may be translucent and/or transparent.

The backdrop materials may also comprise a black material which is light absorbent on the side facing the subject, yet also light-transmissive from the rear. Various types of materials may be used, such as woven cotton or polyester, nylon, perforated fabrics, flocked fabric, or combinations thereof. When combined with a color changeable backlit array, the said black material would allow for a range of dark colored background scenery in captured images, including brightly colored backgrounds (if the light intensities of the backlit array are high enough), even while the subject is well lit from the front lighting elements (because the said black backdrop material will absorb the light from the front lighting elements).

Additional and separately addressable lighting elements may be included in the backlit panel to allow for additional rim lighting effects, such as illuminating the narrow edges of the subject's head and/or torso. The said additional lighting elements for rim lighting effects may be positioned such that they do not block the lighting elements in the backlit array, and they may be mounted to adjustable mounting mechanisms as described for the other system lighting elements.

One alternative to a backlit panel 13 is an electronic visual display which is large enough to cover the entire background. Such a display may use any display technology such as OLED, LED, or LCD, or may be a projected display. This would allow great flexibility in designing the background scenery in captured images, ranging from simple uniform colors to detailed graphic environments by way of high-resolution digital images. Higher pixel density will allow higher levels of detail in background scenery. The display luminosity would be preferably high enough to allow properly exposed background scenery when the subject is substantially illuminated by the other lighting elements. The display would also be preferably non-reflective such that reflections of the other system lighting elements would not appear in the background scenery in captured images. If employing an electronic visual display instead of a light array, no backdrop or light diffusing material in a fixed ‘down’ position should be present because the display would be permanently blocked or obscured in captured images.

A preferred embodiment comprises a means of capturing images. This is accomplished in the illustrated embodiment in FIG. 1 with an image capture device 2 comprising an image sensor and directed towards the photographic zone. The image capture device 2 is preferably disposed towards the front of the system and aligned with the central axis (lengthwise) of the photographic zone but may be disposed in any position so as to capture images within the photographic zone. The image capture device 2 is preferably a digital camera that provides a means of computer control of the shutter (whether mechanical or electronic or other shutter type) as well as obtaining a live (real time video) feed from the image sensor. A professional digital camera may be used which might allow computer-controlled adjustment over several camera parameters—e.g. shutter speed, aperture, image sensor sensitivity (ISO setting), exposure compensation, and digital zoom—as well as a means of obtaining a live feed from the image sensor. Alternatively or additionally, a live feed may be obtained from a separate device comprising an image sensor and disposed in the vicinity of the image capture device 2. It is understood that any number of additional image capture devices may be included in the system to allow for images of different characteristics to be captured simultaneously (e.g. alternative perspectives, alternative orientations, or video recording).

The image capture device 2 may comprise a zoom lens that allows computer-controlled adjustment of optical zoom (i.e. focal length) and/or a fixed focal length lens. It will be understood by those skilled in the art that each type of lens has its merits in terms of quality, versatility, and cost. It will also be understood that optical and digital zoom likewise have merits in terms of quality, versatility, and cost, and that factors such as image processing algorithms (e.g. lens distortion compensation) and desired output formats should be considered.

A preferred embodiment comprises a mounting device configured to provide at least one framing movement to the image capture device 2. This is accomplished in the illustrated embodiment in FIG. 1 with a motorized stand 14 that allows at least the vertical position of the image capture device 2 to be adjusted, thereby allowing vertical framing adjustments of the subject(s) in captured images. The range of the (substantially) vertical motion of the motorized stand 14 may be selected by the system designer, based on factors such as the expected height range of subjects and whether they will be placed on elevated platforms (e.g. persons seated and/or standing). For example, if a particular system is designed to only accept adults in a seated position, then the range of vertical motion of the motorized stand 14 in this case does not need to be nearly as large as compared to a system designed to accept both adults and children in both standing and seated positions. The motorized stand 14 may be constructed by various means (e.g. gantry systems, belt-driven mechanisms, motorized pantographs, rack and pinion mechanisms or electric linear actuators) and mounted onto any surface (e.g. floor, ceiling, or side walls) and configured in such a way as to allow for (substantially) vertical height adjustment.

Alternative configurations may be possible for adjusting the vertically positioning of the image capture device 2. For example, if the vertically adjusting mechanism of the front lighting elements is motorized, the image capture device 2 may be mounted to the front crossbar assembly (rather than the motorized stand) such that the front lighting elements will move together (substantially vertically) with the image capture device 2. In this case, the motorized stand 14 might be used for other purposes such as holding a display, or might instead be a non-motorized stand which is coupled to the said front crossbar assembly, or might be omitted entirely. In another example, if the vertically adjusting mechanism of the front lighting elements is not motorized, the motorized stand 14 may be coupled to the vertically adjusting mechanism (or front crossbar assembly, if present) and thereby drive the front lighting elements together (substantially vertically) with the image capture device 2.

The motorized stand 14 may also comprise a motorized pan and tilt mount for the image capture device 2. As will be understood by those familiar with photography, the term “pan” typically refers to horizontal rotational movement whereas “tilt” typically refers to vertical rotational movement. A motorized pan and tilt control would therefore allow physical rotation (vertical and horizontal) of the image capture device 2 so that it may be pointed towards a particular location in the photographic zone. This would provide the benefits of expanding the possible perspectives of image capture (e.g. an upward tilt would result in the subject “looking down” at the viewer), expanding the possible framings of the scene (e.g. the image capture device 2 may be panned and tilted such that only the lower left side of the photographic zone is visible in the captured image), as well as potentially minimizing perspective and lens distortions of the subject(s) in captured images. Alternatively or additionally, a wide-angle lens may be used in combination with digital cropping (a.k.a. digital zooming) towards one side of the sensor of the image capture device. Whereas a sufficiently wide-angle lens along with digital cropping may provide some benefits of a motorized pan and tilt mount, the technique has well understood disadvantages related to captured image quality and distortions. Digital image processing techniques may alleviate such problems to some degree.

It will be appreciated that a motorized stand with vertical height control as well as pan, and tilt control would allow 3 degrees of freedom, otherwise known as a 3-axis mount in common marketing terminology. Together with a motorized optical zoom lens, this may be considered a 4-axis control system. It will be understood that image capture systems containing fewer or greater degrees of freedom (i.e. axes of adjustment) are still within the scope of the invention. Such degrees of freedom may be obtained by mechanisms such as a roll control mechanism for adjusting between portrait and landscape orientations, a slide control mechanism for moving the image capture device towards or away from the subject (or towards the left or right side of the system), or even a robotic arm having multiple degrees of freedom to allow precise positioning. These types of motorized control systems are all readily available on the market and/or they may be constructed by combining a plurality of control systems together—e.g. a motorized roll control mounted to a motorized pan and tilt control would produce a 3-axis control system.

In a preferred embodiment, at least one display 3 is provided to present a software graphical interface (GUI) which preferably comprises a live feed from the image capture device 2, as explained further below. The display 3 may use any display technology such as OLED, LED, or LCD, and may serve the secondary purpose of a hardware user input device if it is also a touchscreen input device. A projected display (rear or front projected) may be used additionally or alternatively. The display 3 may be mounted to the motorized stand 14 adjacent to the image capture device 2 such that the subject (if human) need not shift their eyes a great distance between the display 3 and the image capture device 2 to adjust posing while taking photos. In an alternative or additional configuration, the display 3 may be a remote or detachable display, or an auxiliary display in addition to a permanently mounted display, allowing the system software to be viewed and controlled remotely inside or outside the photographic zone.

In a preferred embodiment, a computer system (not shown) is interfaced with controllers (not shown) for the lighting elements, the backdrops, the image capture device, the motorized stand, and any system components that may affect the captured compositions and are adjustable. The interfacing between the computer system and the said controllers may be wired and/or wireless.

It will be understood that the computer system comprises a processor and a storage unit with a set of computer-readable instructions executable in said processor. This set of computer-readable instructions may be in the form of a computer-implemented method stored in a non-transitory computer-readable medium.

In a preferred embodiment, a plurality of presets is stored in the storage unit, which may be a memory on the said computer system, a networked computer, a cloud location, a removable storage device, or any location or combination of locations which would be accessible to the computer system, wherein each preset corresponds to a target composition to be captured. Each preset preferably comprises parameter data corresponding to the adjustable and/or motorized elements of the system which affect the captured compositions (e.g. the intensities and colors of the lighting elements, the color of the backdrop to be selected, and the framing parameters of the image capture device). The software and controllers may work together to achieve the desired change in the system configuration as described in the parameter data.

In a preferred embodiment, each preset is represented by an image (or image sequences or other graphical forms) in a software graphical user interface which is running on the computer system (or at a computer-accessible network location) and shown on the display 3. To allow for an intuitive user interface, the preset images may be visual representations of the resulting composition seen by the image capture device 2 upon preset selection. As such, the preset images may comprise images captured in the system itself and/or images captured in other professional studios (as might be found in magazines, fashion catalogs, or other publications or media libraries). For preset images in the latter case, the associated parameter data might be tuned to emulate the professional studio images as closely as possible. The presets may be shown in a “grid view” such that the user may view multiple preset images simultaneously while making a selection. The presets may be organized and grouped into categories, sections, or folders such that the user can more easily navigate among the presets during selection. The preset groupings may be according to mood (e.g. “dramatic”), purpose of session (e.g. “graduation photoshoot”), type of subject (e.g. “fashion product”), or any other characteristic or theme. The software GUI and presets may be configured to provide any common user interface tools and arrangements such as tagging and filtering, sorting (e.g. by popularity or by date added), searching, and folder hierarchies.

As an alternative or additional preset configuration, a two-part preset configuration may be offered—for example, the first part relates to the subject illumination and framing, whereas the second part relates to the background scenery. In such a case, the user may be prompted to select among one set of preset images corresponding to the first part, each preset image showing subject(s) in a lighting pattern (or silhouette) upon a neutral background (indicating subject-specific selection), and then the user may be prompted to select among a second set of preset images corresponding to the second part, each image representing an option for background scenery. Additionally, the user may be able to preview the combined result of the selected subject illumination and framing (first part) over the various background scenery options (second part) before making a selection.

As an alternative or addition to providing the user with selectable presets, the system may provide the user with selectable preset sequences. Each preset sequence may comprise a plurality presets, wherein each preset would be activated in some pre-ordered sequence, thereby guiding the user through a number of photo/video styles, perhaps as a photographer might guide his/her subject during a session. Each preset sequence may be grouped according to mood (e.g. “dramatic”), purpose of session (e.g. “graduation photoshoot”), type of subject (e.g. “fashion product”), or any other characteristic or theme. Such preset sequences may be suitable for users who prefer a simpler and more hands-off experience, while also helping users avoid decision fatigue.

The system may also provide an option for importing a target image and recreating its aesthetics. The target image might be imported by, for example, transferring the target image file from the user's device. Alternatively, the user might be prompted to present the target image in view of the image capture device, or to transfer the target image data over a network/internet location. Upon import, the system may analyze the target image and determine the system parameter settings (e.g. the intensities of each lighting element, backdrop color, and shutter and aperture settings) that may achieve the aesthetic composition in the imported image. Alternatively or additionally, upon import, the system may analyze the target image and compare against the plurality presets in memory to find the closest matches, from which the user may make a selection. It will be understood that various algorithmic methods and user interface elements may be employed for the purpose of recreating the aesthetics of an imported image.

In a preferred embodiment, upon selection of a preset in the software GUI, the computer reads the parameter data stored in the selected preset and sends instructions to the appropriate controllers—e.g. the light controller will receive instructions for the intensity and color of each lighting element, and the controller for the motorized rollers 12 will receive instructions for which backdrop should be visible in the background. It will be understood that any logic or other parameters that depend on system state (e.g. the current backdrop configuration or the current lighting element positions) may be built into the software and/or the controllers to manage system configuration adjustments upon preset selection (e.g. changing from black backdrop to gray backdrop may require rolling the black backdrop up while rolling the gray backdrop down).

An additional software GUI screen may be provided, wherein the following three elements are displayed: the selected preset image, the (real-time) live feed from the image capture device, and the user's last taken photo/video (if one has already been taken). Many alternative GUI screen arrangements may be possible, such as displaying the said three elements in the same layout as a menu of presets. The software GUI screen may be displayed on a single user-facing display or distributed to multiple user-facing displays, each display showing any combination of the said three elements as well as the preset selection menu. The live feed from the image capture device is preferably flipped horizontally, as is commonly done on selfie cameras, such that the user may adjust themselves intuitively as if reflected by a mirror.

If the preset image contains a subject in a pose, then the user may be able to adjust himself/herself while using the preset image as a pose reference or target. Alternatively or additionally, the user may simply ignore the pose in the preset image and pose however he/she prefers. Other methods of pose guidance may be implemented in the software as well, such as providing the option to display alternative poses, providing target pose outlines or other visual elements overlayed upon the live feed from the image capture device, or detecting the user pose by algorithmic techniques and providing visual or auditory guidance to the user for how to adjust the pose. Hardware elements may also be included to help the user pose, such as embedded lighting elements in the floor indicating where the user might position himself/herself to match the pose or any other compositional characteristic in the preset image. It will be understood that the above pose guidance methods and elements are applicable to human subjects or any type of subject to be captured.

The software GUI may comprise various other elements as are common in automated photo capture machines such as a countdown timer indicating the remaining time available for the user's session, and a photo/video browser wherein the user may view photos/videos that have been captured during the session. An “advanced mode” may also be provided to allow more technically adept users to tune system parameters in detail, such as intensities and colors of individual lighting elements. If a speaker is included in the system, the software GUI may output auditory signals for various purposes such as interface button sounds, shutter countdown timers, or pose guidance.

The system may also provide presets for capturing ID or passport photos. Upon selection of such presets, overlayed elements in the live feed from the image capture device could help guide the user to capture the target composition. For example, upon selection of a preset intended for a United States passport application, various graphics and text may be shown overlayed upon the live feed from the image capture device to help the user capture a photo according to the official United States passport photo requirements. The photo may also be automatically cropped and resized upon capture, according to the official requirements. It will be understood that all such ID and passport processing as is commonly available in smartphone applications and ID/passport photo machines may be implemented as features in this system.

In a preferred embodiment, the user is provided with at least one input device to control the system. Hardware input devices such as pedal controllers, handheld remote controllers, or tablet PCs would be suitable for user control. Alternatively or additionally, downloadable software may be provided such that the user may use his/her own mobile device for controlling the system. Any or all such devices may be wireless for a more comfortable user experience. One advantage of pedal controllers is that they may allow the user to trigger the shutter of the image capture device 2 more easily without substantially breaking pose. Handheld remote controllers may be equipped with many types of buttons and other controls, allowing for user control over many features. Such handheld remote controllers may provide a mini qwerty keyboard on one side for entering user details such as their name and email address. The system may optionally allow for gestural recognition or voice command recognition such that body gestures or voice commands may be used for triggering the shutter of the image capture device 2 or controlling other system features. The system may also be designed to allow double presses or a long press of a single control (e.g. a button), such that a single control may serve a dual purpose (e.g. capture single photo versus capture continuous photos). After the user activates the shutter control, the system may use a countdown operation—for example, counting down from 3 seconds—to give the user adequate time to adjust his/her pose before a photo/video is captured.

It will be understood that the user (or whoever is interfacing with system controls) may not necessarily be physically present inside the system structure. For example, a user (whether person or algorithm or other intelligent entity or entities) may control the system from any location inside or outside the system using a tablet computer wirelessly interfaced with the computer system. In another example, a user may control the system from a remote distance using his/her/its own computer running software which interfaces with the primary computer system via a network connection, which may be wired and/or wireless.

In a preferred embodiment, the computer system also performs image processing on both the live feed from the image capture device and the captured photos/videos, according to the selected preset. For example, if the selected preset corresponds to a photographic composition which has been edited with a red tint, then the computer system might apply a red tint via image processing on both the live feed from the image capture device as well as the captured photos/videos. Alternatively, the image processing may be only performed on captured images, while the live feed remains unprocessed. The image processing may also perform the horizontal flip operation, which is commonly done on selfie cameras as described earlier, as well as any digital cropping (a.k.a. digital zoom) or framing. It will be understood that any kind of image processing may be implemented in the system, such as simple brightness/contrast processing or more complex processing such as artificial intelligence (Al) based denoising.

Since professional studio images are often edited (or retouched) after capturing an image, real-time image processing of the live feed may allow the subject the impression of “stepping inside” a professionally edited image in real time (by way of the live feed image processing). It will be understood that the inclusion of image processing helps to expand the range of possible photographic compositions captured by the system, and that image processing parameters may be tuned differently for each preset to provide a variety of professionally edited looks automatically.

Image processing such as background replacement or removal may be included, which is commonly achieved with uniformly lit green or blue backgrounds (and “chroma key” processing). Such green or blue backgrounds may be provided in the system by methods such as including green or blue backdrop materials on the motorized backdrop rollers and illuminating them by the backlit panel 13, or by setting the color changeable lighting elements in the backlit panel 13 to radiate green or blue colored light. It will be appreciated that some advanced background replacement and removal algorithms may produce satisfactory results without such colored backgrounds.

The system may also include a depth sensor positioned and oriented in such a way as to capture depth data in substantially the same field of view as the image capture device 2. One advantage of having depth data would be that the image processing would be able to process the background separately from the subjects with good precision, thereby allowing better results with effects (such as background blurring, background replacement, or skin smoothening) which are becoming common in smartphones which have built-in depth sensors. Other advantages may include improved focus accuracy and speed, improved recognition of gestures for controlling system features, embedding depth data (stored with the captured images) for depth-based post-processing, subject height detection, and subject pose detection. It will be understood that the image capture device 2 itself may include a depth sensor whose output may be sent to the computer system, potentially providing the same benefits as a separate depth sensor.

It will be understood that the variety of available mobile and professional digital camera features, including image processing, may be implemented advantageously as features in this photo system—e.g. face autofocus, photo burst mode, time-lapse, slow-motion video, portrait mode, boomerang video, HDR, red eye removal, and zebra pattern display. The image capture device 2 itself may have built-in features which may be utilized advantageously by the system, in addition to or instead of processing in the computer system hardware/software.

In a preferred embodiment, the system utilizes an automated framing method: a means of automatic and aesthetically based framing of subject(s) in captured images. The automated framing method is operated using the computer system in operative association with the system. The computer system is configured to: display a plurality of preset images on the display device, receive a signal indicating a preset image selection via the input device, determine a first reference point based on the selected preset image, retrieve at least one frame from the image sensor based on a predetermined evaluation frequency, evaluate a second reference point on the retrieved frame, and actuate the mounting device to perform the at least one framing movement to align the second with the first reference point. If said reference points are vertical coordinates and said framing movements are vertical movements, this feature would allow the system to automatically compensate for differences in heights of subjects (in terms of vertical framing) while preserving target aesthetics (as determined by the presets). Such a feature is herein referred to as an automated vertical framing method.

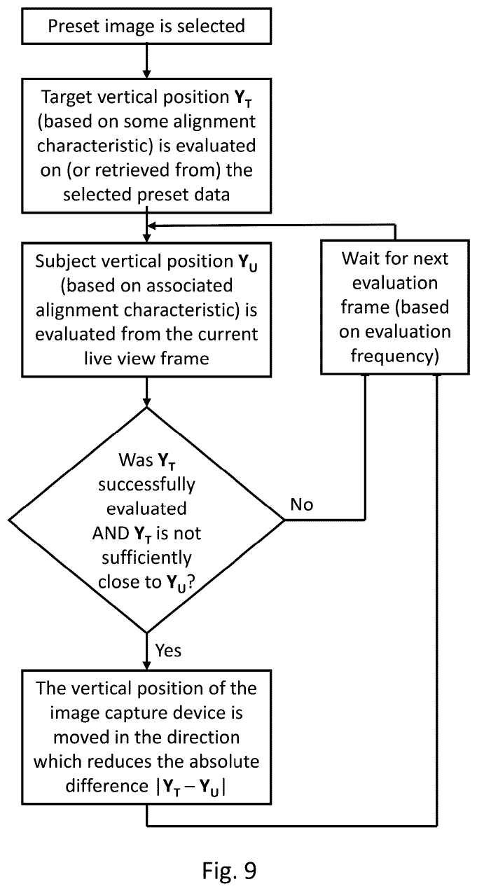

One example automated vertical framing method is shown in FIG. 9, wherein, upon user selection of a preset image, the target vertical position Y_{T} (based on some subject characteristic, e.g. center of head), which is the first reference point, is evaluated on the preset image data or is retrieved from pre-calculated data stored with the preset. Then the subject vertical position Y_{U} (based on an associated characteristic), which is the second reference point, is evaluated from the current evaluation frame (from the live feed of the image sensor or the image capture device), which is the retrieved frame. It will be understood that the term “frame” in this case refers to one still image in the sequence of images of which the said live feed is comprised. If Y_{U} was successfully evaluated and Y_{T} is not sufficiently close to Y_{U}, this indicates the subject is not vertically aligned with subject in the preset image, and therefore the vertical position of the image capture device is moved in the direction that reduces the absolute difference between the target vertical position (Y_{T}) and the subject vertical position (Y_{U}). If Y_{U} was not successfully evaluated (which could be caused by the subject stepping outside the photographic zone, or lens focusing problems or various other reasons), no action should be taken. If Y_{T} is sufficiently close to Y_{U}, this indicates the subject is already sufficiently vertically aligned with the subject in the preset image, and therefore no action should be taken. Whether or not an action is taken for the current evaluation frame, the subject vertical position (Y_{U}) will be re-evaluated on the next evaluation frame, based on some evaluation frequency as selected by the system designer (e.g. once every 10 frames).

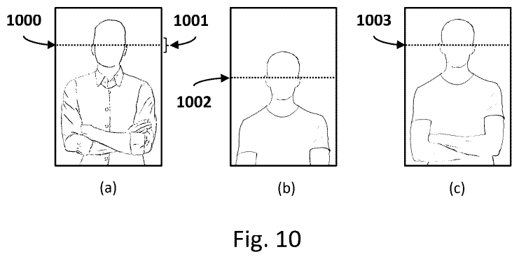

FIG. 10 shows a simple visual representation of the above example automated vertical framing method in operation, wherein the selected alignment characteristic (chosen by the system designer) is the vertical head center level (i.e. the vertical coordinate of the center of the head in the image). For illustrative purposes, all subjects are shown in outline form. The preset image (a) comprises a subject whose vertical head center level is represented by a dotted line 1000. The bracket 1001 denotes the vertical position range in which a candidate vertical head center level will be considered “sufficiently close” to the target. The current evaluation frame from the live feed of the image capture device (b) comprises a subject who is present in the photographic zone, and whose vertical head center level is represented by a dotted line 1002. In accordance with the example method above, the vertical head center level of the subject in the current evaluation frame 1002 will be determined to not be sufficiently close to the target vertical head center level 1000, and therefore the image capture device will be moved vertically downwards in order to reduce the absolute difference between the two vertical head center levels. Assuming the subject in the photographic zone does not move during this time, the image capture device will continue to move vertically downwards while the absolute difference between the vertical head center levels continues to be evaluated (in subsequent evaluation frames) as not sufficiently close. Eventually, assuming the subject in the photographic zone continues to stay still, the absolute difference between the two vertical head center levels will be sufficiently close, as is represented in (c), a future evaluation frame from the live feed of the image capture device, comprising the said subject present in the photographic zone, whose vertical head center level is represented by a dotted line 1003.

In cases where the preset image comprises a plurality of the chosen alignment characteristic (e.g. multiple heads are visible), then the target vertical position may be determined based on a logical or statistical operation on the plurality of detectable vertical positions, e.g. the maximum value or the average value. A logical or statistical operation on the plurality of detectable vertical positions may also apply in cases where the live feed comprises a plurality of the chosen alignment characteristic.

It will be appreciated that a vertical tilt mechanism, if included, may be additionally adjusted with the automated vertical framing method, but that such a method will cause a change in perspective (e.g. looking up at the subject from below), which may be different from the selected preset and may therefore be undesirable to the user.

User controls may be provided to override the automatic stand adjustment, thereby pausing the motion of the motorized stand 14, until some event occurs such as the user canceling the override state or the user selecting a new preset. Other logical controls may also be implemented, such as pausing the automatic stand adjustment at the time a photo is captured to avoid blurry images.

These features are executed through a set of computer-readable instructions in the form of a computer-implemented method stored in a non-transitory computer-readable medium.

It will be appreciated that neither the subject(s) in the preset image nor the subject(s) in the photographic zone are required to be human subject(s) in order to take advantage of the automated vertical framing method—the same method may be applied to animals, products, or subjects of any kind, either in the preset image or in the live feed of the image capture device. It is left to the system designer to decide on the alignment logic under all the various possible circumstances—e.g. a situation where an inanimate object in the preset image while a human subject is in the live feed, or a situation where a human and an animal in the preset image while a human is alone in the live feed—based on the intended use cases. Different alignment methods or different alignment characteristics may be activated depending on the types of subjects present. Alternatively, the algorithm may be paused depending on the types of subjects present (based on additional detection of the types of subjects present).

It will be understood that many variations of this automated vertical framing method are possible, while still being within the scope of the invention. For example, the alignment characteristic may be the human face, head, torso, outline, or any other characteristic or combinations thereof. Using the human head versus the face may be preferred for situations where heads are turned to the side, causing faces to be undetectable in the field of view of the image capture device. Alternatively, the alignment characteristic might not be specifically defined, as in the case of a machine learning algorithm trained to determine whether subject(s) in a live feed are vertically higher or lower than subject(s) in a selected preset image. In another example, rather than perform an image processing detection algorithm on the live feed from the image capture device 2, said detection algorithm may be performed on the live data feed from a secondary image sensor such as a range sensor or another image capture device comprising a photographic image sensor. A secondary image sensor whose field of view is greater than the image capture device 2 may be beneficial for various situations, such as when the selected alignment characteristics of the subject(s) move outside the field of view of the image capture device 2 while still being within the field of view of the secondary image sensor. In another example, the live feed from the image capture device 2 is digitally manipulated by image processing to allow for a particular compositional effect (e.g. digitally cropped), in which case the automated vertical framing method might be based on the processed data from the live feed of the image capture device 2 rather than the unprocessed live feed data. In another example, the automated vertical framing method may be accomplished by adjusting the digital framing (i.e. cropping) in addition to or instead of adjusting the motorized stand 14.

The automated vertical framing method may additionally be used for adjusting the elevation of the lighting elements. For example, if a human subject moves from a standing to seated position in the photographic zone, upon evaluation (by the automated vertical framing method) of the shift in subject vertical position, a signal may be sent to the electric hoist system to adjust the elevation of the lighting elements to preserve the elevation angles relative to the subject's new (seated) position. This method of operation may provide an additional benefit: since the elevation of the lighting elements would be adjusted continuously and automatically, no adjustment step would be required for setting the elevation of the lighting elements according to a formula as described earlier.

It will be appreciated that a system that utilizes all the aforementioned features will allow for the unique user experience of capturing professional studio quality images in a matter of seconds, by themselves and without professional assistance. With the lighting arrangement adjusted for a subject's height and providing aesthetically proven lighting patterns, the background scenery switchable and modifiable with front and rear lighting, the software providing a live feed of the user's appearance as well as pose guidance, the image capture device continuously adjusted to optimize the vertical framing of the subject, the image processing automatically editing and retouching the images, and the entire system adjustable with professionally designed presets, users are all but guaranteed to capture great quality compositions automatically.

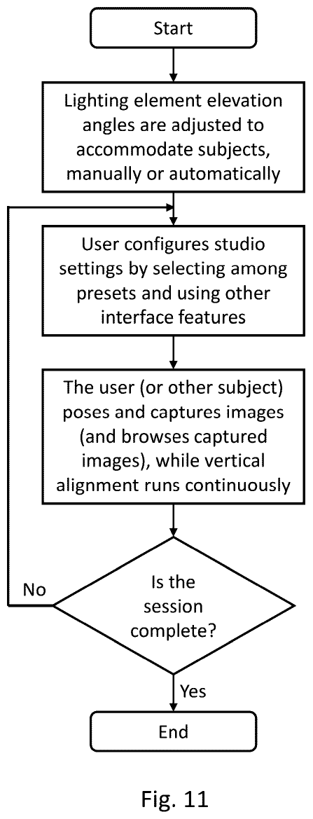

An example method of operation for a new user session is shown in the block diagram in FIG. 11. At the beginning of a new session, the elevation of the lighting elements is adjusted according to the height of the subject(s)—this may be achieved by motorized and/or non-motorized means as described earlier. The user then configures the studio settings by selecting among presets and using the available tools for creative adjustment as desired. Then the user (or other subject or plurality thereof) poses and captures images and may browse captured images as well. Meanwhile, the automated vertical framing method is running continuously to vertically align the subject(s) in frame. The user may continue the process of adjusting studio settings, capturing images and so forth until the session is complete, based on some fixed time limit or other criteria.

The system may also provide a means of capturing professional quality images from a user's own image capture device in addition to, or instead of, the built-in image capture device 2. For example, a mounting location for a user's smartphone upon the motorized stand 14 may be provided such that the user may capture images using their preferred smartphone camera and applications. Additionally or alternatively, a wired connection may be provided, such that if the user were to connect his/her smartphone, the system may access the live feed from the smartphone camera to be processed in the system software, as well as control the smartphone camera shutter for capturing images. In a related example, the system software may prompt the user to download a smartphone application designed to control the system interface and transfer data (e.g. image data) between the smartphone and the system wirelessly.

One intuitive tool for creative adjustment that may be provided by the system is a color hue offset control, which would allow the user to simultaneously adjust (i.e. offset) the color hue of all lighting elements which are assigned a color, while substantially maintaining the color hue distances (with respect to a color space) in the selected preset. Various mathematical methods may be used for hue adjustment, such as offsetting the RGB values of the lighting elements in HSL space, as is commonly done in photo editing algorithms. The color hue offset control may be relative in nature, such that any adjustments to the color hue offset control value will be relative to the initial color hues as defined in the selected preset. The color hue offset control may be endless/cyclical in nature, such that incrementing or decrementing the control value in one direction will eventually return the color hue offset control value to the original value. Endless rotary encoders are hardware knobs that are commonly used for such relative and endless parameter controls, but it will be appreciated that a color hue offset control may take many interfacing forms, such as a knob in the software GUI, increment/decrement buttons in the software GUI, a hardware joystick, or a pair of increment/decrement buttons on a hardware remote.

As an example of operation of the said color hue offset control in the system, upon selection of a particular preset which instructs the backlit panel 13 light array to emanate a (uniformly) red light, a front-positioned lighting element to emanate a green light, and a side-positioned lighting element to emanate a white light, then the color hue offset control may be used to simultaneously change the color hue of the backlit panel 13 light array together with front-positioned lighting element, without affecting the white light. Since the backlit panel 13 light array and the front-positioned lighting element are emanating different color hues from the start, as described by the selected preset, then the lights will remain different color hues while the color hue offset control is adjusted. When using color transformations based on an HSV model, for example, a 90-degree adjustment of the color hue offset control might result in the red light changing to green, and the green light changing to cyan.

The color hue offset control may adjust only the color hue while the color saturation remains constant, as has been implemented in theatrical lighting control systems. The system may also include a separate color saturation offset control to allow the user to simultaneously adjust (i.e. offset) the color saturation of all lighting elements which are assigned a color. It will be appreciated that any such color controls may be functionally tied together with any color-oriented image processing (as performed on the live feed from the image capture device 2 as well as the captured images). For example, if a particular preset describes a front-positioned lighting element emanating a red color as well as image processing performing a green tint, then the color hue offset control might simultaneously adjust both the hue of the front-positioned lighting element as well as the hue of the tint in image processing, while substantially maintaining the original hue distances.

It will be understood that many other variations of color-related controls may be implemented, such as a color brightness/intensity control which may adjust the lumen output of the colored elements while preserving color hue and saturation, or a color control which adjusts color characteristics of white lights (if composed of colored elements). Controls for color-related parameters for each individual white and colored lighting element might be made available to users in an “advanced mode.”

Another intuitive tool for creative adjustment that may be provided by the system is a symmetrical lighting flip control, which would perform a left-to-right side mirroring operation on the lighting element intensities. Since each preset comprises lighting element intensities intended for a particular subject pose (and composition), a symmetrical lighting flip control would allow subjects to adjust their pose in a mirrored version of the lighting—which would be useful, for example, if the subject prefers to emphasize the left side of their face as opposed to the right—while maintaining the general aesthetic quality of lighting. This control would be most effective for symmetrically designed systems, wherein every lighting element on the left side of the photographic zone has a counterpart of equivalent size and luminosity on the right side. An example operation of such a control is as follows: given a system with symmetrically placed left and right side lighting elements as well as a centrally placed front lighting element, and given a selected preset wherein the left side lighting element is assigned to maximum intensity, the right side lighting element to zero intensity, and the front lighting element to medium intensity, pressing the symmetrical lighting flip control would assign the left side lighting element to zero intensity and the right side lighting element to maximum intensity (i.e. symmetrically flipped intensities), while maintaining the front lighting element at medium intensity because it is centrally placed on the axis of symmetry. When adjusting the intensities of the lighting elements, the symmetrical lighting flip control may simultaneously perform a horizontal flip of the selected preset image, such that the flipped lighting patterns are consistent with the selected preset image.

The system may include a plurality of auxiliary displays to allow the subject to see himself/herself more easily when facing away from the camera. It will be appreciated that subjects commonly face away from the camera for particular aesthetic effects in professional studio images, and therefore the presence of additional displays might allow the subject to see himself/herself more easily in such types of poses. Any additional display device may also be used to display the software GUI in part or in full, and such devices may also serve as additional hardware input devices if they are also touchscreen input devices.

Various special effect studio devices may be integrated into the system, such as fog machines, bubble machines, blower fans, and UV lights. Such devices may be integrated such that they may be activated upon selecting particular presets. In such cases, the said presets may be represented as images (or image sequences or other graphical forms) in the software GUI which display the visual result upon activating the corresponding special effect studio device(s).

The system may also include provisions for capturing images of animals. For example, the plurality of preset images may comprise images of animals. In another example, the software may include an “animal mode” wherein upon activating the shutter, the system will provide visual or auditory signals to direct the attention of the animal subject towards the image capture device 2 or any other direction or induce some change in posture or behavior in the animal. Such signals may include animations on a display, animated lighting near the image capture device 2 or elsewhere, and/or sound output from speakers disposed near the image capture device 2 or elsewhere. The visual or auditory signals may be tailored to specific types of animals such as dogs versus cats, in which case a plurality of selectable animal modes may be provided for each animal (e.g. “dog mode” or “cat mode”).

The system may also include one or more microphones for recording acoustic signals while recording video. It will be understood that directional microphones—e.g. cardioid pattern—may be pointed towards the photographic zone such that sound sources outside the photographic zone may be reduced relative to sound sources inside the photographic zone.

The captured images may be transferred to the user by any number of commonly implemented methods, continuously during the session or in a single event upon session completion—examples of methods include hosting the images on an in-house web server, hosting the images with a cloud storage service, providing a hardware interface (e.g. a USB port) for the user to transfer to their own device over a wired connection, or providing a means of transferring wirelessly to the user's mobile device. The image output formats may be any photo, video or related format as appropriate.

Various other system elements may be provided as may be suitable for any particular use case. For example, commercial-use systems designed according to the present invention may provide movable studio furnishings such as stools and benches, photographic accessories such as reflectors, and replacement backdrop materials. In another example, public entertainment-oriented systems may provide a means of coin/token based operation, a proximity sensor for detecting the presence of a person for a new session, soundproofing within the outer structure, an area outside of the photographic zone but within the outer structure such that the user (or his/her companions) may move out of the photographic zone while images of a subject are being captured, a speaker system and interface for playing music (of the user's choice and/or depending on the selected preset or preset sequence), a mirror for adjusting appearance, and a photo printer. In another example, the system may be packaged as a consumer product (including mounting structures) to be assembled by the customer, who might use his/her own smartphone to serve the functionalities of an image capture device, a computer system, an input device, and/or a display.

Particular attention should be given to the construction of a fully automated machine for use by the general public (where no system operator is present), such that users (or any person) may not easily damage or vandalize system components or otherwise hinder its operation. Such a system may use a damage-resistant inner (and outer) surface wherein the lighting elements are mounted flush to the inner surface and protected by a damage-resistant transparent/translucent material, and no cabling is exposed to the user. A transparent, non-reflective, durable and scratch resistant panel might be positioned in front of the backdrops to prevent damage to the backdrop materials or other components at the rear of the system. An additional transparent, non-reflective, durable and scratch resistant panel might be used in front of the motorized stand, image capture device, and user-facing display to avoid user damage to these components.

It will be appreciated that any system element as described herein may have its functionality replaced (i.e. offloaded) partially or fully by any other system element (or any external element) as may be permitted by the functionality of the available elements. For example, the image capture device 2 may have built-in memory storage in which the plurality of presets as well as captured images may be stored, as opposed to computer system storage. In another example, the user facing display 3 may have a built-in processor upon which the image processing may be run, thereby offloading image processing from the computer processor. In another example, a plurality of systems according to the present invention may be placed in the same vicinity and utilize a central computer system or server (e.g. a dedicated server or cloud server) for running any computer-related tasks (such as running the software for each system independently or hosting the plurality of presets and associated preset images).

It will be appreciated that the system may make advantageous use of various new technologies as they become available—for example, more efficient or higher quality lighting elements, new electrically adjustable colored fabric for backdrops, advancements in robotics and sensor technologies for the various motorized and sensor-based elements, new human-machine interfaces for software control, and new image output formats and transfer methods.

It will be understood that many variations of the system are possible and therefore the present invention may be practiced otherwise than as specifically described herein without departing from the spirit and scope of the invention.

1. An automated image capture system comprising:
a photographic zone for accommodating at least one subject, said photographic zone comprising a front section and a rear section;
a plurality of lighting elements surrounding the photographic zone;
at least one display device configured to display an information;
at least one input device configured to receive control signals;
an image sensor configured to obtain a plurality of frames containing the at least one subject; and
a mounting device configured to provide at least one framing movement to the image sensor;
characterized in that said automated image capture system is in operative association with a computer system, said computer system comprising a processor and a storage unit with a set of computer-readable instructions executable in said processor, characterized in that said computer system is configured to:
display a plurality of preset images on the display device;
receive a signal indicating a preset image selection via the input device;
determine a first reference point based on the selected preset image;
retrieve at least one frame from the image sensor based on a predetermined evaluation frequency;
evaluate a second reference point on the retrieved frame; and
actuate the mounting device to perform the at least one framing movement to align the second with the first reference point.

2. The automated image capture system according to claim 1, characterized in that an image capture device comprises said image sensor, said image capture device is disposed behind at least one of the plurality of lighting elements located in the front section.

3. The automated image capture system according to claim 1, characterized in that said first image sensor is disposed behind at least one of the plurality of lighting elements located in the front section, and that the system comprises a second image sensor which is a range sensor.

4. The automated image capture system according to claim 1, characterized in that said first reference point is a vertical position of a first predetermined characteristic of the selected preset image and said second reference point is a vertical position of a second predetermined characteristic of the retrieved frame containing the at least one subject.

5. The automated image capture system according to claim 4, characterized in that said first predetermined characteristic is a vertical head center level of the preset image and that said second predetermined characteristic is a vertical head center level of the at least one subject.

6. The automated image capture system according to claim 1, characterized in that said at least one framing movement comprises a vertical movement and/or a vertical tilt.

7. The automated image capture system according to claim 1, characterized in that the plurality of lighting elements are disposed at a predetermined set of angles with respect to a reference subject head position, said predetermined set of angles comprises a central azimuth angle θ_{A} and a central elevation angle θ_{E}, said angles being measured clockwise from an axis running from a back side to a front side of a reference subject head position.

8. The automated image capture system according to claim 7, characterized in that the central azimuth angle θ_{A} and the central elevation angle OE of the plurality of lighting elements are set within at least one of the following ranges:
a) θ_{A}=−15° to +15°, θ_{E}=+15° to +65°;
b) θ_{A}=−15° to −75, θ_{E}=+15° to +65°;
c) θ_{A}=+15° to +75, θ_{E}=+15° to +65°;
d) θ_{A}=−75° to −115, θ_{E}=−15° to +25°;
e) θ_{A}=+75° to +115, θ_{E}=−15° to +25°;
f) θ_{A}=−25° to −75, θ_{E}=−15° to +25°;
g) θ_{A}=−25° to −75, θ_{E}=−15° to +25°;
h) θ_{A}=−15° to +15, θ_{E}=−80° to −20°;
i) θ_{A}=−120° to −170, θ_{E}=−30° to +30°; and
j) θ_{A}=+120° to +170, θ_{E}=−30° to +30°.

9. The automated image capture system according to claim 7 further comprising an adjustable mounting mechanism for each of the plurality of light elements to preserve said central azimuth angle and said central elevation angle for an effectively shifted reference subject head position.

10. The automated image capture system according to claim 9, characterized in that the computer system is further configured to actuate the adjustable mounting mechanism based on a subject height input.

11. The automated image capture system according to claim 8, characterized in that the photographic zone comprises a height-adjusting platform implemented on a floor of said photographic zone to preserve said central azimuth angle and said central elevation angle for an effectively shifted reference subject head position.

12. The automated image capture system according to claim 7, characterized in that each of the plurality of lighting elements further comprises a plurality of vertically stacked lighting elements, characterized in that the computer system is further configured to activate one of the vertically stacked lighting elements based on a subject height input.

13. The automated image capture system according to claim 10, characterized in that the computer system is further configured to transmit an instruction to the display device, capture an image of the subject using the image sensor, and estimate the subject height using a predetermined set of instructions.

14. The automated image capture system according to claim 12, characterized in that the computer system is further configured to transmit an instruction to the display device, capture an image of the subject using the image sensor, and estimate the subject height using a predetermined set of instructions.

15. The automated image capture system according to claim 1 further comprising a backlit panel disposed at the rear section of the photographic zone and at least one backdrop mounted on a motorized roller disposed in front of said backlit panel, characterized in that said backdrop is a light-transmissive material, characterized in that the computer system is further configured to determine the backdrop based on the selected preset image and to actuate the roller to roll down said backdrop.

16. The automated image capture system according to claim 2, characterized in that said computer system is further configured to adjust a plurality of image capture device settings based on a selected preset image, said plurality of image capture device settings comprising shutter speed, aperture, image sensor sensitivity (ISO setting), exposure compensation, and digital zoom.

17. A computer-implemented method for framing adjustment of an image capture system, the method comprising:
a) displaying a plurality of preset images on a display device;
b) receiving a signal indicating a preset image selection via an input device;
c) determining a first reference point on the selected preset image;
d) retrieving at least one frame from an image sensor based on a predetermined evaluation frequency;
e) evaluating a second reference point on the retrieved frame; and
f) actuating an image sensor mounting device to align the second reference point with the first reference point.

18. The computer-implemented method according to claim 17, characterized in that the first reference point is a vertical position of a first predetermined characteristic of the selected preset image and the second reference point is a vertical position of a second predetermined characteristic of the retrieved frame containing the at least one subject, characterized in that said first predetermined characteristic is a vertical head center level of the preset image and that said second predetermined characteristic is a vertical head center level of the at least one subject.

19. The computer-implemented method according to claim 17 further comprising a step of receiving a height value from the input device and actuating a mounting device for a plurality of lighting elements according to a predetermined set of rules.

20. The computer-implemented method according to claim 17, characterized in that an image capture device comprises said image sensor.

21. The computer-implemented method according to claim 17, characterized in that a live data feed is transmitted from the image sensor to the display device.

22. The computer-implemented method according to claim 17 further comprising a step of adjusting a color and an intensity of a plurality of lighting elements based on a selected preset image.

23. The computer-implemented method according to claim 17 further comprising a step of adjusting a plurality of image capture device settings based on a selected preset image, said plurality of image capture device settings comprising shutter speed, aperture, image sensor sensitivity (ISO setting), exposure compensation, and digital zoom, based on the selected preset image and on user-defined settings.

24. A non-transitory computer-readable medium configured to perform the method according to claim 17.

25. A plurality of automated image capture systems according to claim 1, characterized in that said plurality of image capture systems is in operative association with the computer system.

26. A plurality of automated image capture systems according to claim 25, characterized in that said computer system further comprises a plurality of computer-readable instructions retrievable from a network location, said plurality of computer-readable instructions corresponding to each of the plurality of automated image capture systems.
